(19) United States
(12) Patent Application Publication
(10) Pub. No.: US 2002/0031998 A1
(43) Pub. Date: Mar. 14, 2002

(54) Method of and device for processing poultry to be slaughtered

(75) Inventor: Herman Kerstholt, Helmond (NL)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Holland United Food Processing Equipment B.V., Helmond (NL)

(21) Appl. No.: 09/934,856

(22) Filed: Aug. 23, 2001

Related U.S. Application Data
(60) Provisional application No. 60/227,028, filed on Aug. 23, 2000.

(51) Int. Cl. A22C 21/00

(52) U.S. Cl. 452/188

(57) ABSTRACT

For handling animals in the form of poultry that are to be slaughtered, which animals are hung on a conveying element so as to be supplied to slaughtering means, the two legs of an animal being supplied in upright position are each actively gripped by means of two gripping elements comprising claws that are movable with respect to each other. Then the two gripping elements are pivoted so as to turn the animal upside down in a position which is suitable for handing over the animal to the conveying element and wherein the animals can be properly orientated.

### FIELD OF THE INVENTION

The present invention relates generally to the processing of poultry and, more specifically, to a method of and a device for processing poultry to be slaughtered.

### BACKGROUND OF THE INVENTION

In slaughterhouses and the like, the poultry are usually hung by their legs on a circulating conveying element in order to be carried past various stations in the slaughterhouse.

Despite several devices and systems for automated handling of poultry to be slaughtered, such as disclosed by the International patent application WO 97/45005, in practice, chickens and the like are generally hung on the conveying element by hand, which is an unpleasant and tiring activity and which, moreover, can easily lead to undesirable injury to the poultry.

In order to overcome difficulties of having to grip chickens which are sitting down when hanging poultry on the conveying element by hand, U.S. Pat. No. 5,129,857 proposes a device by means of which it can be achieved that the poultry is in any case supplied in an upright position, so that they can he easily gripped at their legs. Also with this devices the eventual hanging of the poultry on the conveying element must still be carried out by hand.

### SUMMARY OF THE INVENTION

It is an object of the present invention to provide an improved method of and a device for the automated processing of poultry to be slaughtered.

In a first aspect the present invention provides a method for handling animals in the form of poultry that are to be slaughtered, which animals are hung on a conveying element so as to be supplied to slaughtering means, wherein each of the two legs of an animal being supplied in upright position is gripped by means of a gripping element comprising claws that are movable with respect to each other, after which the two gripping elements are pivoted so as to turn the animal upside down to a position which is suitable for handing over the animal to the conveying element.

When using the method according to the invention it is possible to actively grip the animal, for example a chicken, firmly by its two legs, with the aid of mechanical means, and subsequently pivot it to a position suitable for hooking the legs on to the conveying element.

For the processing of poultry to be slaughtered, it is required that the poultry are orientated in a prescribed direction.

In a further embodiment of the method according to the invention, for proper orientating an animal being gripped by means of the gripping elements and being turned upside down, the two gripping elements are turned through an angle of about 90° in a direction in which the two legs of the animal being gripped are moved together, the gripping elements are then jointly turned through an angle of about 180°, after which the two gripping elements are each turned back through about 90° again.

In a yet further embodiment of the method according to the invention, for the proper orientation of an animal being gripped by means of the gripping elements and being turned upside down, the animal being gripped by means of the gripping elements is handed over to further gripping elements, said further gripping elements are turned through an angle of about 90° in a direction in which the two legs being gripped by the further gripping elements are moved together, the further gripping elements are then jointly turned through an angle of about 180°, after which the two further gripping elements are each turned back through about 90° again.

Whether or not an animal has to be orientated in the prescribed direction can be detected by suitable detection means, among others video cameras and the like.

According to another aspect of the invention, there is proposed a device for handling animals in the form of poultry to be slaughtered, which device is provided for hanging the animals by their legs on a conveying element for moving the animals during the slaughtering process, wherein the device includes two gripping elements, which each comprise claws that are movable with respect to each other, whilst the gripping elements are connected to a manipulator, by means of which the gripping elements can be moved between a position suitable for gripping the legs of animals being supplied in upright position and a position suitable for hanging the legs of the animals on said conveying element.

The animals being supplied can be gripped automatically and safely by means of the actively operated gripping elements according to the invention, and subsequently be pivoted to a position suitable for being hooked on to a usual conveying element.

In a yet further embodiment of the invention, in order to turn an animal being gripped by means of the gripping elements in a specific orientation, the two gripping elements are arranged for turning through an angle of about 90° in a direction in which the two legs being gripped are moved together, and wherein the gripping elements are arranged for being jointly turned through an angle of about 180°.

Instead of arranging the two gripping elements for orientating the animal, in accordance with the invention a separate orientation device or carrier can be provided, comprising further gripping elements arranged for orientation of the animal as disclosed above This separate orientation device can be suspended to a conveying element or conveyor track, and arranged for taking over an animal being gripped by the two gripping elements after being turned upside down,

In accordance with a yet further embodiment of the present invention, the gripping elements can be detachably connected to a manipulator arm and/or a conveying element or a conveying track.

The invention will now be explained in more detail with reference to the accompanying drawings.

### BRIEF DESCRIPTION OF THE DRAWINGS

FIG. 1 schematically shows a possible arrangement of means for supplying the poultry, manipulators and conveying elements by means of which the poultry can be moved.

FIG. 2 schematically shows the principle of the operation of the gripping elements.

FIG. 3 schematically shows a possible embodiment of a gripping element.

FIG. 4 schematically shows another possible embodiment of gripping elements.

FIG. 5 shows a possible embodiment of the attachment of the gripping elements to a manipulating arm.

FIG. 6 schematically shows a side view of FIG. 5 with some changes with respect to the embodiment according FIG. 5.

FIG. 7 schematically shows the manner in which it can be provided that all animals being supplied are provided in the same orientation to the conveying element for moving the animals during the slaughtering process.

FIG. 8 shows schematically a plan view of further gripping elements.

FIGS. 9 and 10 show embodiments of entry gutters.

FIG. 11 schematically shows a perspective view of a manipulator arrangement for turning an animal upside down.

### DETAILED DESCRIPTION OF THE EMBODIMENTS

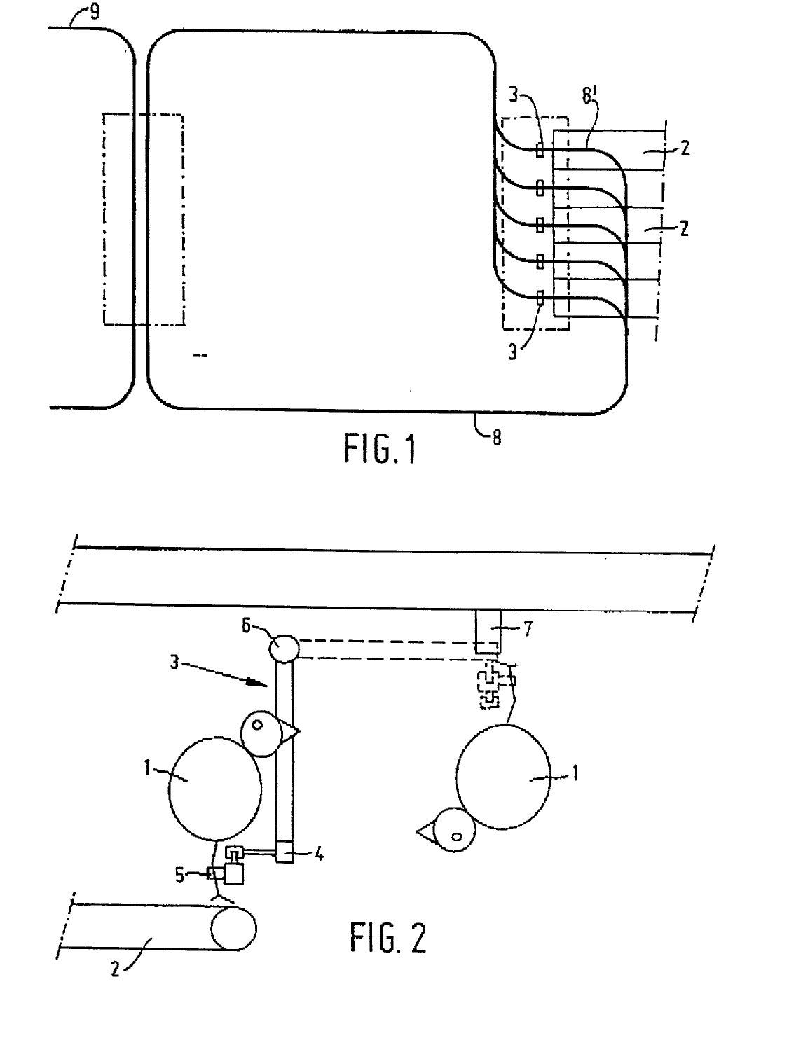

As is schematically shown in FIG. 2, the animals, for example chickens 1, will be supplied in succession by means of a conveying element 2 to a manipulating device, which includes an L-shaped manipulating arm 3, to a horizontal leg 4 of which two gripping elements 5 yet to be described in more detail are attached. Each of the gripping elements will grip one leg of the animal 1, so that the animal 1 can be held firmly and safely by the two gripping elements 5. Then the manipulating arm 3 can be pivoted about a horizontally extending pivot axis 6 to the position illustrated in dotted lines in FIG. 2, whilst at the same time the gripping elements 5 are pivoted with respect to the horizontal leg 4 of the manipulating arm 3, about a pivot axis extending parallel to the pivot axis 6, all this in such a manner that the chicken 1 held by the gripping elements 5 is pivoted through 180° and is thus suspended from the gripping elements 5 by its legs. The combination of gripping elements 5, which are connected to the manipulating arm 3, for example by means of a snap mechanism or the like, is then taken over from the manipulating arm 3 by a carrier 7, which is movable, together with a large number of similar carriers 7, along a closed or endless conveyor track 8, schematically shown in FIG. 1.

As is furthermore shown in FIG. 1, several supplying elements 2 for supplying poultry may be disposed adjacent each other, such as seven or eight supplying elements 2, wherein a supplying element 2 may for example consist of a device of the type as disclosed in the aforesaid U.S. Pat. No. 5,129,857 or the Netherlands patent application No. 1018662 assigned to the Assignee of the present patent application, which Netherlands patent application is herein incorporated by reference. Since it is important for the correct operation of the device according to the present invention that the chickens are supplied in upright position, i.e. stand-up, to the manipulating arms 3, schematically shown in FIG. 1, that are disposed near the delivery ends of the supplying elements 2.

As will be appreciated from FIG. 1, the endless track 8 includes a common part and a number of branches 8′, along which the carrier or supporting elements 7 can be carried for the purpose of handing over the gripping elements 5 to the manipulating arms 3, after which the supporting elements 7 are carried further along the common part of the track 8 in order to receive gripping elements carrying an animal at a point located further down the track 8.

As is furthermore indicated in FIG. 1, part of the track 8 extends parallel to the conveying element 9, which generally consists of a conveyor chain, by means of which the animals to be slaughtered are carried past various stations in the slaughterhouse (not shown). In this circuits in which the conveyor chain 9 and the common part of the track 8 extend parallel to each other, the legs of the chickens or poultry will be moved into known receiving elements for the chickens or poultry that are circulated by the conveying element 9, after which the gripping elements 5 are actuated to release the legs of the animals, so that the animals can be moved further through the slaughterhouse in a usual manner by means of the conveying element 9. The empty gripping elements 5 will then be moved along the track 8 with the supporting elements 7 in order to be supplied to one of the manipulating means 3.

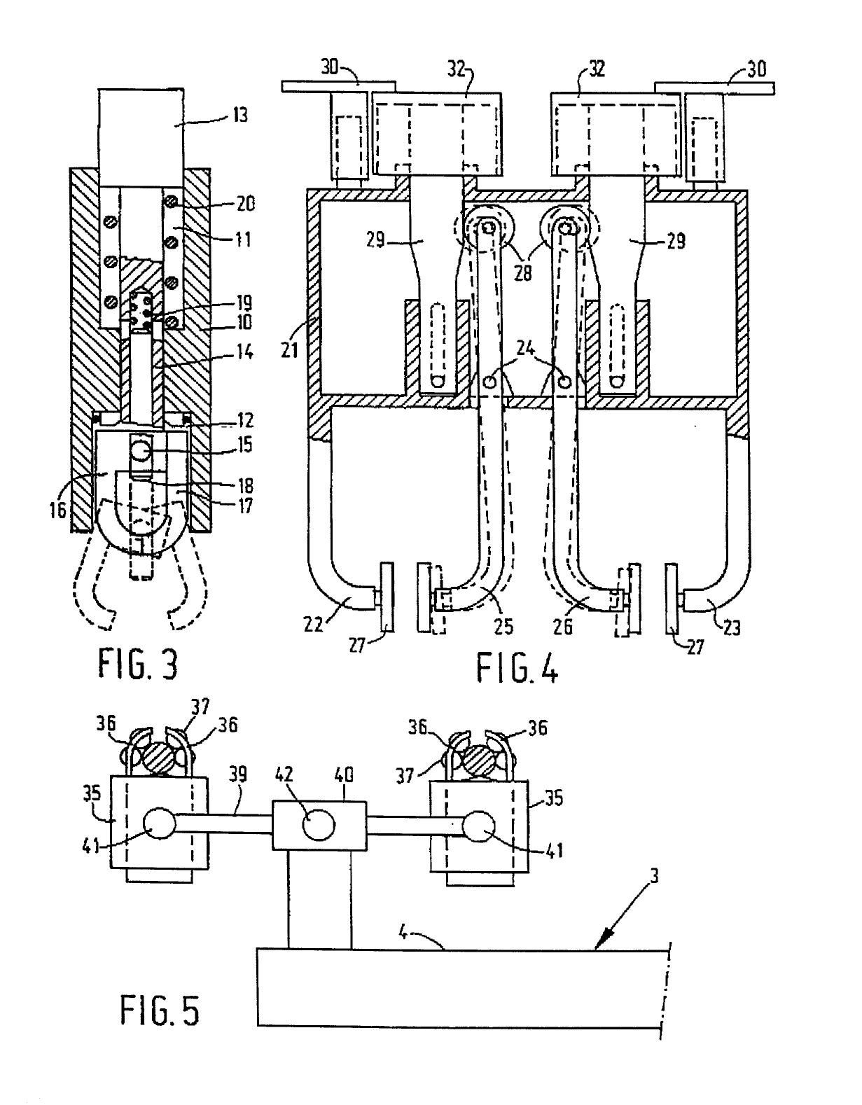

A possible embodiment of a gripping element is schematically shown in FIG. 3. As is shown in this figure, the gripping element comprises a housing 10, in opposite ends of which bores 11 and 12, respectively, are formed. A piston-like body 13 is slidably accommodated in bore 11. Connected to said piston-like body is a rod 14, which extends through a bore formed in a part of the housing 10 that separates the two bores 11 and 12. Two claws 16 and 17 are pivotally connected to the end of the rod 14 extending into the bore 12 by means of a pivot pin 15 that crosses the longitudinal axis of the rod 14 perpendicularly. In a closed position of the claws 16 and 17 as illustrated in solid lines, in which position the free ends of the claws abut against each other, the claws are at least partially contained within the bore 12, whilst in the open position of the claws as illustrated in broken lines, the free ends of the claws are spaced some distance apart, so that the leg of an animal can move between said ends into the space bounded by the claws 16 and 17.

A bore is furthermore formed in rod 14, in which bore a pin 18 is movable against the force of a spring 19 accommodated in said bore.

The part of the rod 13 that is contained in the bore 11 is surrounded by a compression spring.

For example, when a set of gripping elements as described with reference to FIG. 3 is coupled to a manipulator 3, the piston-like body 13 will be pressed into the bore 11 against the tension of spring 20 by means of a cam mechanism (not shown) or the like, in such a manner that the claws 16 and 17 will be moved to the position illustrated in broken lines in FIG. 3. To this end a spring mechanism (now shown), for example a torsion spring wound round pin 15, may be disposed between the claws 16 and 17, which torsion spring attempts to urge the claws to their open position.

The piston-like body 13 can be retained in this position by means of a suitable locking mechanism, until a leg of a chicken moves the tracer pin 18 so as to release said locking mechanism, as a result of which the piston-like body 13 will move upwards, seen in FIG. 3, whilst the ends of the claws 16 and 17 will pivot together, so that the leg of the chicken will be retained within the space bounded by the claws 16 and 17.

Another possible embodiment of gripping elements is shown in FIG. 4.

In this embodiment a common housing 21 is used for both gripping elements, which housing includes two fixed claws 22 and 23 and two claws 25 and 26, respectively, which cooperate with said fixed claws and which are pivotable about pivot axes 24. Attached to the ends of said claws are discs 27, which are rotatable with respect to said claws about a commons imaginary, horizontally extending (seen in FIG. 4) axis of rotation.

The pivotable claws 25 and 26 are in the form of levers that pivot about pivot axes 24, which levers are provided with rollers 28 at their ends remote from the discs 27. Said rollers abut against the outer circumference of pins 29. Said pins can be pressed upwards from the position shown in FIG. 4 by means of compression springs (not shown). This movement is prevented by blocking means 30, however, which cooperate with heads 32 attached to the upper ends of pins 29 in the position shown in FIG. 4, in such a manner that said heads are retained in the position shown in FIG. 4. The blocking means 30 can be adjusted with the aid of suitable control means so as to release the heads 32, so that the pins 29 will be pushed upwards in that case. The rollers 28 that are pressed against the outer circumference of the pins by spring means (not shown) will thereby be moved into abutment with thinner parts of pins 29, whilst the pivotable claws 25 and 26 will pivot to the position that is illustrated in broken lines in FIG. 25, in which position the gripping elements occupy an open position for receiving the legs of animals between the discs 27. When the legs of the animals are positioned between the discs 27, this can be detected by means of suitable sensors, so that the gripping elements 22, 25 and 23, 26 will be returned by suitable driving means to the position which is illustrated in solid lines in FIG. 4, in which position the legs of the chickens are clamped between the discs 27.

When the gripping elements described with reference to FIG. 4 are being pivoted by means of a manipulator 3, the animal that is clamped between discs 27 can rotate along with said discs with respect to the other parts of the gripping elements about the aforesaid imaginary, common axis of rotation of the discs 27.

It will be appreciated that thus several embodiments of gripping elements suitable for use with the construction according to the invention are conceivable, such as disclosed in FIG. 8.

FIG. 5 schematically shows an embodiment wherein two gripping elements 35 are coupled to the horizontal leg 4 of a manipulating arm 3. The gripping elements 35 may, for example, be configured in the manner described above with reference to FIG. 3.

In this embodiment, however, freely rotatable balls 37 are accommodated in claws 36, in order to enable easy pivoting of the claws with respect to the legs 38 of an animal being held by the gripping elements 35, which will be important when orienting suspended animals into a desired position in a manner yet to be described in more detail.

The gripping elements 35 are mounted on the ends of a rod 39, which is pivotably accommodated, about its longitudinal axis extending parallel to the aforesaid pivot axis 6 of the manipulating arm 3, in a supporting block 40 that is positioned centrally between the two gripping elements 35 so as to enable the pivoting movement of the gripping elements 35 with respect to the manipulating arm 3 as described above with reference to FIG. 2.

Each of the gripping elements can be furthermore pivoted with respect to the rod 39 about an axis 41 extending perpendicularly to the longitudinal direction of the rod 39, whilst the supporting block 40 that supports the gripping elements 35 can pivot about an axis 42 extending parallel to the axes 41.

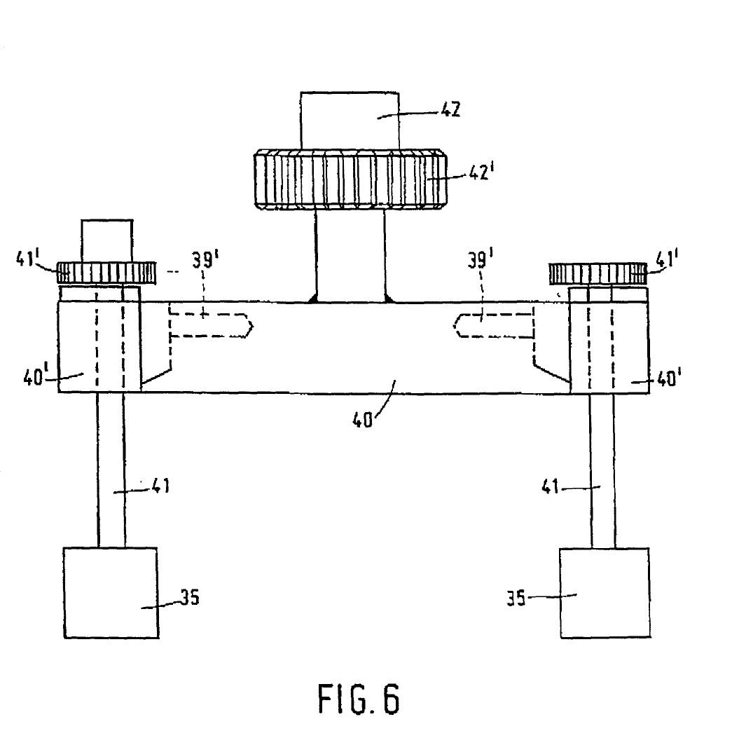

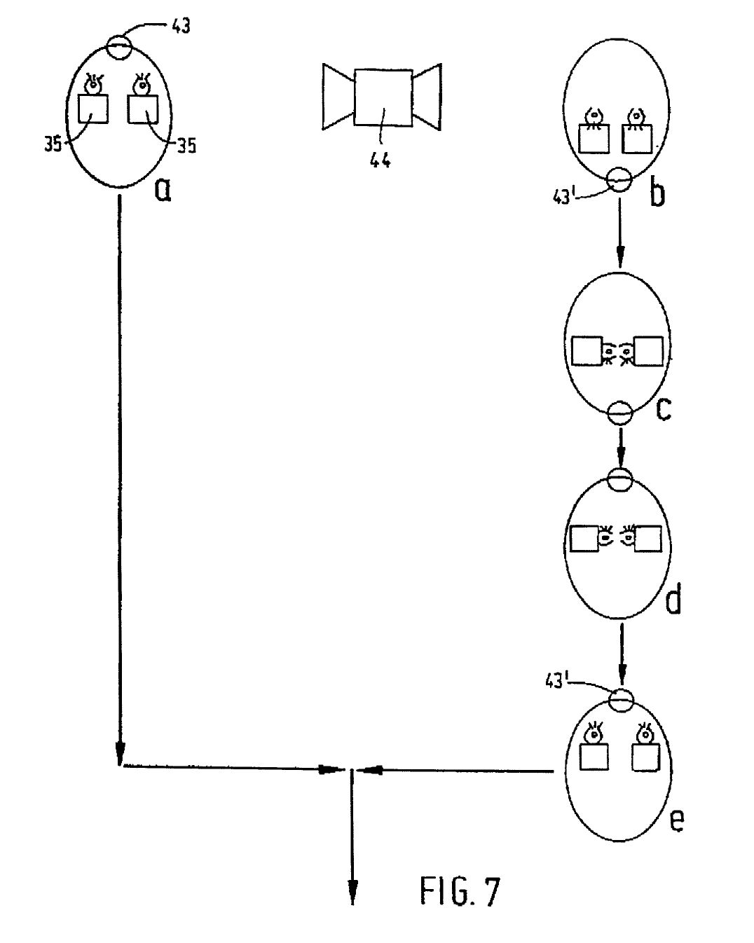

FIG. 6 shows a side view of an embodiment substantially similar to the embodiment of FIG. 5. In both figures corresponding parts have been designated with the same references.

In the embodiment according FIG. 6 the shafts 41 are journalled in blocks 40′ which can be rotated with respect to the supporting block 4a about axes 391.

On the shaft 42 and the shafts 41 there have been fixed gear wheels 42′ and 41′ resp. for rotating said shafts for bringing the animal in a proper orientation position. Drive means for rotating the gear wheels are not explicitly shown, but may co-operate with the means for driving the track 8. The shafts 41 may be pivotable in the plane of the figure.

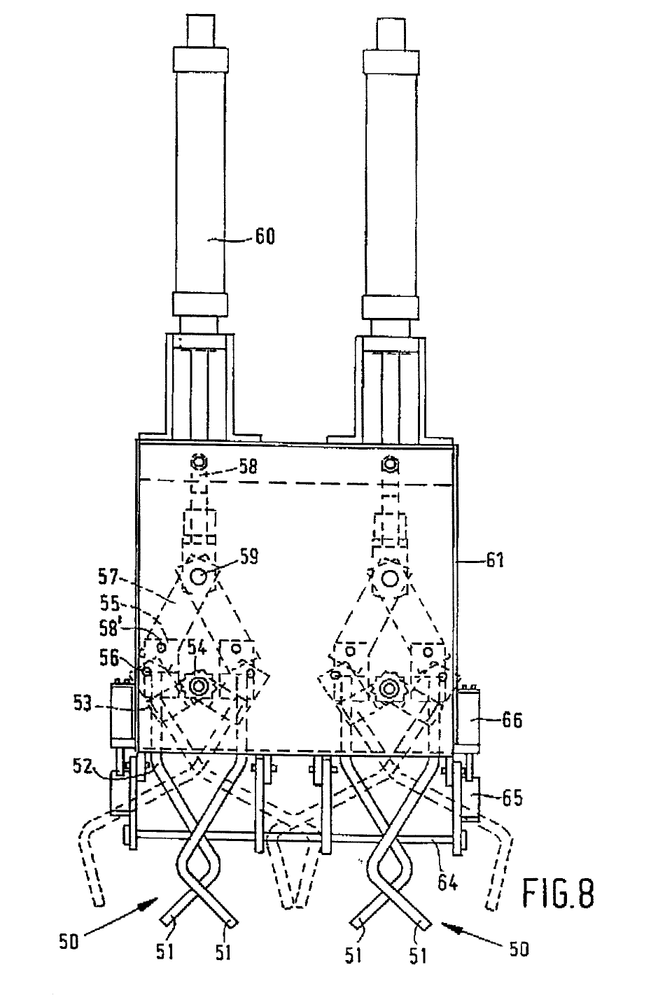

As will be explained below with reference to FIG. 7, a desired orientation of a suspended animal can be effected in a simple manner by using a construction of this kind.

The fact is that in the slaughterhouse all animals being supplied are required to have the same orientation, in other words, the heads of the animals must all point in the same direction.

When animals are being supplied, a situation may occur wherein an animal is standing the wrong way around, so that, as is schematically shown in FIG. 7, in one case the head 43 occupies a suitable position with respect to gripping elements 35 (FIG. 7a), whilst in the other case the head 431 occupies a position turned through 180° relative to the desired position (FIG. 7b), seen in the intended direction of movement of the animals as indicated by arrows in FIG. 7. When using the construction which is schematically shown in FIGS. 5 or 6, it is now possible to pivot the two gripping elements 35 towards each other through 90°, as is shown in FIG. 7c, and furthermore to pivot the gripping elements 35 together about the axis 42 as shown in FIG. 7d, after which the gripping elements 35 can be pivoted back to their original position about axes 41 (FIG. 7e), so that eventually also the head 43′ of the animal will occupy the same position with respect to the gripping elements as shown in FIG. 7a. It will be appreciated that it is thus possible in a simple manner to effect the same orientation for all the animals that are being supplied to the conveying element for moving the animals during the slaughtering process.

Whether or not an animal has to be orientated in a manner as shown in the right-hand part of FIG. 7 can be detected by suitable detection means, such as suitably positioned cameras and the like, schematically indicated by reference numeral 44.

In particular, the gripping device of FIG. 6 can operate as a further gripping element with a carrier or supporting element 7 carried by the track 8 and arranged for taking over the gripped animal and, if required, for orientating same in the proper direction for further processing thereof with orientation elements constructed and operated as disclosed above with reference to FIGS. 5 and 6.

Instead of being mounted to the manipulator arm 3, the arrangements of the gripping elements 35 shown in FIGS. 5 and 6 can be provided as separate orientation elements or carriers 7 supported by the closed or endless conveyor track 8, as schematically shown in FIG. 1.

FIG. 8 shows a further embodiment of gripping elements. Each gripping element 50 comprises two L-shaped claws 51. One of the legs of each L-shaped claw 51 has been provided with an extension 52 which is fixed to a supporting block 53. The block 53 is guided in a housing so as to be in engagement and rotatable about a toothed wheel 54.

The block 53 has been coupled to a link 55 by means of a pivot pin 56. The link 55 is coupled to the end of a further link 57 by means of a pin 58′ extending parallel to the pin 56.

Two links 57 associated with the two claws 51 of a gripping element 50 are at their ends remote from the links 55 coupled to the end of a piston rod 58 by means of a pin 59 extending parallel to the pins 56 and 58. The piston rod 58 is connected with a piston accommodated in a pneumatic cylinder 60 which has been fixed to a housing 61 accommodating the above cited elements 50-59. As indicated in FIG. 8 by moving the piston to and from in the cylinder 60, the claws 51 can be moved between an open position of the claws 51 of the gripping element 50 shown in dotted line to a closed position of the claws 51 of the gripping element 50 shown in solid lines, In said closed position a leg of an animal will be enclosed by the two claws 51.

For closing the two claws 51, a sensing or tracer mechanism has been provided, comprising an abutment rod 64, which extends at a distance from the housing 61 at the end thereof at which the claws 51 extend from the housing 61.

The abutment rod 64 connects to actuator means 65 which are operatively engaged with a proximity switch 66. In the embodiment shown in FIG. 8, on each side of the housing 62 a proximity switch 66 and actuator means 65 are located.

The proximity switches 66 may be of any suitable type, such as photo detectors, capacitively operated detectors, magnetically operated detectors and the like. In the case of a photo detector switch 66, the actuator means 65 may comprise means for changing the amount of light incident on the photo detector switch 66. In the preferred embodiment of the invention, the proximity switches 66 are capacitively triggered switches, wherein the actuator means 65 comprise a metallic plate or the like such that when the distance of the plate to the proximity switch 66 various, a trigger signal will be provided for closing the claws 51, i.e. from the position shown in dotted lines to the position shown in solid lines in FIG. 8.

Means for actuating the piston rods 58 via the proximity switches 66 are generally known to those skilled in the art, and need not to be elucidated.

Those skilled in the art will further appreciate that, instead of an abutment rod 64, other sensing mechanisms or tracer mechanisms can be provided for closing the claws 51, such as, but not limited to, optical light ray means, providing a light ray which is interrupted by the legs of an animal ones the animal is in a position to be gripped by the claws 51.

Those skilled in the art will appreciate that, instead of a pneumatic cylinder 60 for driving the claws 51 of the gripping element 50, hydraulically or electrically operated driving means can be used.

After gripping the legs of an animal by means of the two gripping elements 50 the further handling of the animal can be done as explained above.

With the gripping elements as disclosed by the present invention, an animal can be actively gripped ones it is in a position that there is a possibility to grip the legs of the animal. This is different from gripping means having fixed, fork type gripping elements, for example, into which an animal is moved by a conveying element. Thus, gripping elements without actively operated claws or the like.

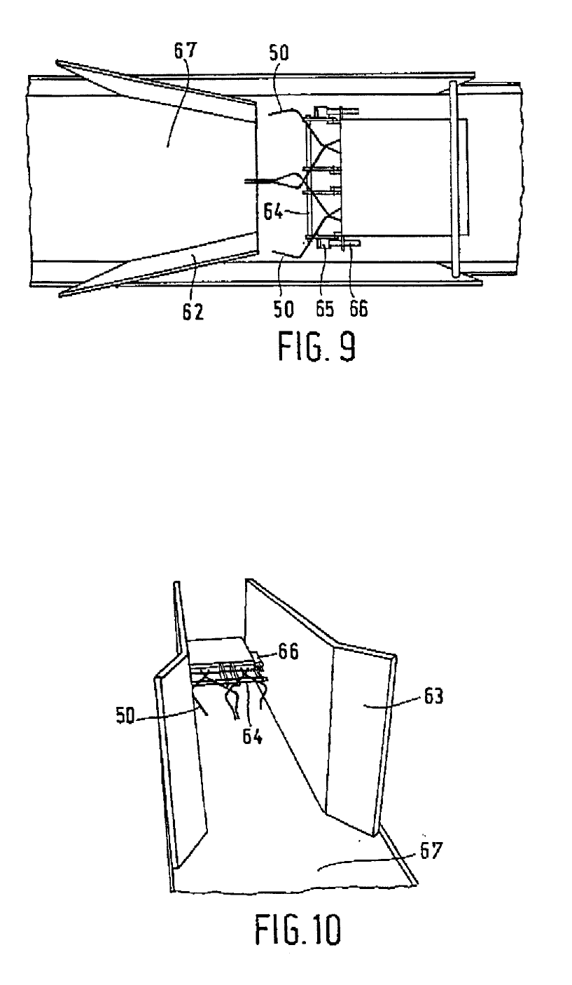

As shown in FIG. 9, the animals can be moved towards the gripping elements 50 by means of a conveyor belt 67. In the embodiment according FIG. 9 there have been arranged in front of the gripping members upwardly extending guiding plates 62, the arrangement being such, that in the direction towards the gripping elements 50 the distance between said guiding plates 62 gradually decreases for obtaining a good guiding of the animals in an upright or standing-up position towards the gripping elements 51.

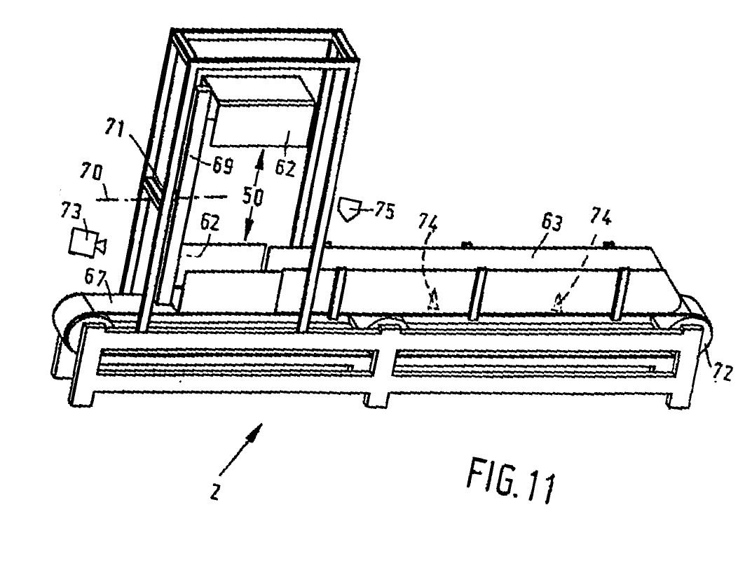

In the embodiment shown in FIG. 10, wherein parts corresponding with the parts shown in FIG. 9 have been indicated with the same reference numbers as used in FIG. 9, there are used relatively long guiding plates 63 in front of the gripping elements 50. Using relatively long guide plates 63 provides a smoother movement of the animals towards the gripping elements 50 In a practical embodiment a number of conveyor belts 67 with guide plates 62 or 63 can be arranged like the conveying elements 2 shown in FIG. 1.

FIG. 11 shows, in a perspective view, an embodiment of a supplying element 2 (FIG. 1) comprising a conveyor belt 67, a housing 62, and gripping elements 50 connected at each end of a manipulating arm 69 which is pivotably arranged about axis 70, which is schematically indicated by a dash-dot line. The manipulating arm 69 may be driven by driving means 71 in a step-wise manner,

Once an animal which is moved by the conveyor belt 67 towards a gripping element 50 is gripped, the animal will be turned upside down by pivoting the manipulator arm 69 in a manner such that the gripping elements 50 at the apposite end of the manipulator arm 69 are located in the position shown for receiving an animal supplied by the conveyor belt 67.

The animal, in its upside down position, will then be handed over to further gripping elements, such as the gripping elements shown and disclosed above with respect to FIGS. 5 and 6, which further gripping elements may be attached to a carrier 7 of the track 8 (FIGS. 1 and 2) arranged for moving towards and from the gripping elements 50 holding an animal in its upside down position, in order to handed over the animal to the further gripping elements of the track 8.

The further gripping elements may be attached to a carrier plate which can be moved between the supporting plates 62 of the gripping elements 50 for handing over the animal and for the proper orientation thereof, if necessary, as disclosed above with reference to FIG. 7.

In a preferred embodiment of the receiving elements 2 as shown in FIG. 11, driving means 72 of the conveyor belt 67 are arranged for controlling the speed of the conveyor belt 67 in response to the gripping of an animal by the gripping elements 50.

In the case that the claws 51 are activated for gripping the animal by its legs, the speed with which the animal is supplied by the conveyor belt 67 can be reduced or the conveyor belt 67 can be even stopped in order to ensure an adequate and reliable gripping of the legs of the animal by the gripping elements 50. Once the animal has been gripped and turned upside down through operating the manipulator arm 69, the speed of the conveyor belt 67 can be increased for supplying another animal to the gripping elements 50, etcetera.

In the case of animals which are Death on Arrival (DoA) or for any other reason cannot be gripped by their legs, mass detecting means are provided, such as video cameras and the like as schematically indicated by reference numeral 73, which are operatively connected to the actuating means for actuating the claws 51 of the gripping elements 50, in order to prevent that the DoA are gripped by the claws 51.

By gradually pivoting the manipulator arm 69 into the position for turning the animal upside down, the DoA will fall out of the housing 62 of the gripping elements 50 into a suitable container or the like disposed adjacent the supplying element 2 (not shown).

As already explained above, for a proper gripping of the animals by their legs, it is required that the animals are supplied to the gripping elements in an upright position. To this end, injection means 74 can be provided for injecting water or the like between the supporting plates 63 in order to cause the animals to stand up.

Further, in order to minimize the risk of uncontrolled movements of an animal supplied to the gripping elements 50, shielding or screening means 75, preferably in the form of means for creating a haze screen of water drops, smoke, or the like are positioned near the gripping elements 50, as schematically disclosed in FIG. 11.

Means for providing a haze screen may comprise RF generator means for creating a screen of fine water drops from a water container which can be arranged beneath the conveying belt 67, for example (not shown).

Although the present invention has been elucidated with reference to a number of preferred embodiments, those skilled in the art will appreciate that the invention is not restricted to the embodiments shown and that several variations and modifications can be made by a person skilled in the art without applying inventive skills and within the scope of the invention as defined in the attached claims.

1. A method for handling animals in the form of poultry that are to be slaughtered, which animals are hung an a conveying element so as to be supplied to slaughtering means, wherein each of the two legs of an animal being supplied in upright position is gripped by means of a gripping element comprising claws that are movable with respect to each other, after which the two gripping elements are pivoted so as to turn the animal upside down to a position which is suitable for handing over the animal to the conveying element.

2. A method according to claim 1, wherein for orientating an animal being gripped by means of the gripping elements and being turned upside down, the two gripping elements are turned through an angle of about 90° in a direction in which the two legs of the animal being gripped are moved together, the gripping elements are then jointly turned through an angle of about 180°, after which the two gripping elements are each turned back through about 90° again.

3. A method according to claim 1, wherein for orientating an animal being gripped by means of the gripping elements and being turned upside down, the animal is handed over to further gripping elements, said further gripping elements are turned through an angle of about 90° in a direction in which the two legs being gripped by the further gripping elements are moved together, the further gripping elements are then jointly turned through an angle of about 180°, after which the two further gripping elements are each turned back through about 90° again.

4. A device for handling animals in the form of poultry to be slaughtered, which device is provided for hanging the animals by their legs on a conveying element for moving the animals during the slaughtering process, wherein the device includes two gripping elements, which each comprise claws that are movable with respect to each other, whilst the gripping elements are connected to a manipulator, by means of which the gripping elements can be moved between a position suitable for gripping the legs of animal5 being supplied in upright position and a position suitable for hanging the legs of the animals on said conveying element.

5. A device according to claim 4, wherein for orientating an animal being gripped by means of the gripping elements and being turned upside down, the two gripping elements are arranged for turning through an angle of about 90° in a direction in which the two legs being gripped are moved together, and wherein the gripping elements further are arranged for being jointly turned through an angle of about 180°.

6. A device according to claim 4, wherein said manipulator includes a pivotable manipulating arm, to which a set of gripping elements can be detachably connected.

7. A device according to claim 6, wherein said manipulator comprises a manipulating arm that can pivot through an angle of about 90°, to which arm two gripping elements can be detachably connected, in such a manner that said gripping elements can be pivoted through an angle of about 90° with respect to the manipulating arm.

8. A device according to claim 4, wherein said manipulator includes a pivotable manipulating arm at each end of which a set of gripping elements is connected.

9. A device according to claim 8, comprising driving means for driving said pivotable manipulating arm in a step-wise manner.

10. A device according to claim 4, comprising a further conveying element on which the gripping elements are hung after having gripped an animal, wherein part of said conveying element extends parallel to the conveying element for moving the animals during the slaughtering process for the purpose of handing over the animals from the gripping elements to suspension elements that form part of the conveying element for moving the animals during the slaughtering process.

11. A device according to claim 10, wherein said further conveying element includes carriers to which the gripping elements can be detachably connected and by means of which said gripping elements can be supplied to a manipulator.

12. A device according to claim 10, wherein that said further conveying element includes carriers comprising further gripping elements arranged for turning through an angle of about 90° in a direction in which the two legs being gripped are moved together, and wherein the further gripping elements are arranged for being jointly turned through an angle of about 180°.

13. A device according to claim 12, wherein said further gripping elements comprising claws that are movable with respect to each other for gripping a leg of an animal.

14. A device according to claim 4, wherein said claws of said gripping elements include freely rotatable balls accommodated in said claws, which balls engage the legs of the animals.

15. A device according to claim 13, wherein said claws of said further gripping elements include freely rotatable balls accommodated in said claws, which balls engage the legs of the animals.

16. A device according to claim 4, wherein said gripping elements are attached to a common carrier, which is accommodated in a support in such a manner as to be pivotable about a horizontal axis.

17. A device according to claim 4, wherein said gripping elements are pivotable through an angle of about 90° with respect to a carrier interconnecting said gripping elements.

18. A device according to claim 17, wherein said carrier with the gripping elements is pivotable about an axis that extends at least substantially parallel to the axes about which the gripping elements are pivatable with respect to the carrier.

19. A device according to claim 4, wherein a gripping element includes at least one pivotable jaw.

20. A device according to claim 4, wherein a gripping element comprises two substantially L-shaped claws which can be pivoted to and from between a closed position and an open position.

21. A device according to claim 4, wherein the device has been provided with a conveyor for moving the animals towards the gripping elements between guide plates arranged at opposite sides of the conveyor.

22. A device according to claim 4, wherein the device has been provided with a conveyor for moving the animals towards the gripping elements, said conveyor comprising driving means for controlling the conveying speed of the conveyor.

23. A device according to claim Z2, wherein said means for controlling the conveying speed are operatively coupled to actuating means for actuating the gripping elements.

24. A device according to claim 4, wherein the device has been provided with a conveyor for moving the animals towards the gripping elements, further comprising means for shielding adjacently positioned animals on said conveyor.

25. A device according to claim 24, wherein said shielding means comprise means for providing a haze screen.
